(19) United States
(12) Patent Application Publication
(10) Pub. No.: US 2012/0014001 A1
(43) Pub. Date: Jan. 19, 2012

(54) OPTICAL LENS UNIT AND PLASTIC LENS FORMING MOLD AND PLASTIC LENS MANUFACTURING METHOD THEREFOR

(75) Inventor: Ichiro Kurihara, Sukagawa-city (JP)

(73) Assignee: KANTATSU CO., LTD., Yaita-shi (JP)

(21) Appl. No.: 13/234,378

(22) Filed: Sep. 16, 2011

Related U.S. Application Data
(63) Continuation-in-part of application No. 12/943,143, filed on Nov. 10, 2010, now abandoned.

(30) Foreign Application Priority Data
Jul. 13, 2010 (JP) 2010-158587
Jan. 21, 2011 (JP) 2011-011007

(51) Int. Cl. G02B 7/02; B29D 11/00; B29C 45/56

(52) U.S. Cl. 359/819; 425/577; 264/1.7

(57) ABSTRACT

Disclosed is an invention that aims to accurately position a lens barrel and an optical lens and form a plastic lens easily with a high-precision forming mold. A plastic lens is formed by filling resin into a cavity surrounded by a fixed mold, a movable mold, and inserts, which are removably incorporated into respective molds. A lens portion and conical surfaces of the plastic lens are formed with the inserts. This provides enhanced forming accuracy by making the conical surfaces and lens portion concentric with each other. When the plastic lens is to be incorporated into the lens barrel, the conical surface of the plastic lens is allowed to be in line contact with the vertical inner circumferential surface of the lens barrel to make the plastic lens concentric with the lens barrel for the purpose of accurate positioning.

### CROSS REFERENCE TO RELATED APPLICATION

This application is a Continuation-in-part of U.S. application Ser. No. 12/943,143, filed Nov. 10, 2010, the contents of which are incorporated herein by reference.

The present application is based on and claims priority of Japanese patent application No. 2011-011007 filed on Jan. 21, 2011, and Japanese patent application No. 2010-158587 filed on Jul. 13, 2010, the entire contents of which are hereby incorporated by reference.

### BACKGROUND OF THE INVENTION

1. Field of the Invention

The present invention relates to an optical lens unit for use as an optical lens that is to be incorporated, for instance, in a mobile phone, a mobile terminal, a common zoom lens, or a digital camera. More specifically, the present invention relates to the optical lens unit that permits highly accurate positioning of an optical lens and a lens barrel. The present invention also relates to a plastic lens forming mold and plastic lens manufacturing method for the optical lens unit.

2. Description of the Related Art

As the market for mobile terminals with an imager has expanded in recent years, the imager has been upgraded to incorporate a high-pixel-count, small-size solid-state image sensing device. In a situation where such a high-pixel-count, small-size image sensing device is increasingly employed, an imaging lens having plural lenses is commonly used as described, for instance, in Japanese Patent Laid-Open Publication No. H9-113783 (patent document 1) and Japanese Patent Laid-Open Publication No. 2005-338869 (patent document 2).

The imaging lens described in Patent document 1 includes one plastic lens, one glass lens, and a lens barrel incorporating these lenses. Peripheral portions of the plastic lens and glass lens that are in contact with each other are provided with the same curvature surfaces or the same tapered surfaces. When the lenses are to be fitted into a lens frame, the lens barrel and the plastic lens are positioned while the contact portion of the plastic lens, which is to be initially fitted into the lens frame, is abutting on a receiving surface of the lens barrel. In the resulting state, the glass lens is engaged with the inner circumferential surface of the lens barrel, pressed against the plastic lens, and pressurized in the direction of an optical axis so that the plastic lens is sandwiched between the lens barrel's receiving surface and the glass lens. The same curvature surfaces or the same tapered surfaces, which are formed on the peripheral portions of the lenses, are then engaged with each other to align the optical axes of the lenses.

The imaging lens proposed in Patent document 2 includes a lens barrel and plural plastic lenses. The lens barrel incorporates these plastic lenses alone. The imaging lens used, for instance, in a mobile phone is generally configured so that the lens barrel incorporates only plastic lenses, which can be molded with ease. In a digital camera or the like, on the other hand, a zoom lens is mainly used. In this instance, the lens barrel generally incorporates glass lenses only or the combination of a glass lens and a plastic lens as described in Patent document 1. As shown in FIGS. 3 and 4, the imaging lenses described in Patent document 1 and Patent document 2 are formed in such a manner that the outside diameter of the plastic lens is slightly smaller than the inside diameter of the lens barrel. The plastic lens is inserted into the lens barrel while radial clearance to the lens barrel is maintained. While the lens inserted into the lens barrel is pressed in the direction of the optical axis, a final lens is secured with glue or secured with a lens retainer press-fitted into the lens barrel.

As regards the imaging lens described in Patent document 1 or Patent document 2, a receiving surface U of a first plastic lens R1, which is initially inserted into the lens barrel K, is allowed to abut on an abutting surface K1, which is formed on the lens barrel K, as shown, for instance, in FIG. 3. The receiving surface U and the abutting surface K1 are then made perpendicular to the optical axis. While the first plastic lens R1 is positioned in the direction of the optical axis, the subsequent plastic lenses, namely, a second and subsequent plastic lens R2, . . . (the glass lens in Patent document 1), are sequentially inserted into the lens barrel K. Conical surfaces T formed on superposing surfaces of edge portions R1a, R2a of the lenses R1, R2 are then allowed to mate with each other (or engage with each other) so that a unit is formed with the optical axes of the lenses R1, R2 aligned. Eventually, a last-inserted final lens is glued or otherwise fastened to the inner circumferential surface of the lens barrel K.

However, the outside diameters of the lenses R1, R2, . . . disposed in the lens barrel K to form the unit are smaller than the diameter of the lens barrel K so that a slight clearance is provided between the lenses R1, R2, . . . and the lens barrel K. Therefore, when the receiving surface U of the initially inserted plastic lens R1 is allowed to abut on the abutting surface K1 of the lens barrel K, all the unitized plastic lenses R1, R2, . . . are positioned relative to the lens barrel K. Further, the receiving surface U of the plastic lens R1 and the abutting surface K1 of the lens barrel K are made perpendicular to the optical axis. Therefore, the plastic lenses R, R2, . . . can move in the radial direction by an amount equivalent to the radial clearance between the plastic lenses R1, R2, . . . and the lens barrel K. It means that the positioning accuracy of the plastic lenses R1, R2, . . . relative to the lens barrel K is inadequate.

Under the above circumstances, the lens barrel K and the plastic lens R1 initially inserted into the lens barrel K can be radially positioned in order to prevent the positioning accuracy from being degraded by the radial clearance between the plastic lenses R1, R2, . . . and the lens barrel K. For example, a structure similar to a centering structure for the plastic lenses R1, R2 can be employed for the initially inserted plastic lens R1 and the lens barrel K. More specifically, when, as shown in FIG. 4, a tapered conical surface T1 and a conical receiving surface T2 are respectively formed on the receiving surface U of the plastic lens R1 and the abutting surface K1 of the lens barrel K, and then the conical surface T1 and conical receiving surface T2 are allowed to mate (or engage) with each other, the lens barrel K and the plastic lens R1 can be radially positioned in the same manner as achieved by the centering structure for the plastic lenses R1, R2. In this manner, the lens barrel K and the plastic lens R1 can be made concentric. When the second and subsequent plastic lenses R2, . . . are sequentially superposed over the plastic lens R1, which is positioned to be concentric with the lens barrel K, and the conical surfaces T formed on the lenses R1, R2, . . . are allowed to mate with each other, plural plastic lenses R1, R2, . . . can be accurately positioned relative to the lens barrel K.

Meanwhile, the plastic lens R employed for the above-described optical lens is injection-molded with a forming mold. A common structure of such a plastic lens forming mold will now be described with reference to FIG. 5. The plastic lens forming mold includes a fixed mold 100 and a movable mold 101. A lens portion R′, which is the most important part of an optical lens, is formed by inserts 100A, 101A, which are removably incorporated into the molds 100, 101. The edge portion Ra of the plastic lens R, which includes a conical surface Ta positioned on the outer circumference of the lens portion R′, is formed with the fixed mold 100 and movable mold 101. More specifically, the fixed mold 100 and movable mold 101, which are brought into contact with each other at the time of mold clamping, are formed with a high-rigidity material. On the other hand, the inserts 100A, 101A, which form the lens surface of the lens portion R′, are precision-cut after their surfaces are nickel-plated. The fixed mold 100 and movable mold 101 are formed as parts structurally separate from the inserts 100A, 101A. The inserts 100A, 101A are to be incorporated into the fixed mold 100 and movable mold 101. Therefore, the fixed mold 100 and movable mold 101 need clearance for incorporating the inserts 100A, 101A. Due to the clearance for incorporating the inserts 100A, 101A, radial displacement might occur between the conical surface Ta formed by the fixed mold 100 and movable mold 101 and the lens portion R′ formed by the inserts 100A, 101A. In other words, a forming error might occur due to radial variation between the conical surface Ta and the lens portion R′. Consequently, it is anticipated that the position accuracy of the lens portion R′, which mates with the conical receiving surface T2 of the lens barrel K, might deteriorate.

### SUMMARY OF THE INVENTION

The present invention has been made in view of the above circumstances, and provides an optical lens unit and a plastic lens forming mold and a plastic lens manufacturing method for such an optical lens unit that make it possible to accurately position a lens barrel and an optical lens optical axis and accurately form an optical lens.

According to a first aspect of the present invention, there is provided an optical lens unit including a cylindrical lens barrel, which has an opening at both ends, and a plastic lens, which is housed and disposed in the lens barrel. The plastic lens includes an edge portion, which is positioned on an outer circumference, and a lens portion. A tapered conical surface is formed on the outer circumference of the edge portion. The inner circumferential surface of the lens barrel is a vertical surface that is in line contact with the conical surface.

According to the optical lens unit described in the first aspect, when the plastic lens is incorporated into the lens barrel, the lens barrel and the plastic lens are accurately made concentric with each other while the conical surface on the outer circumference of the edge portion of the plastic lens is in line contact with the vertical inner circumferential surface of the lens barrel.

According to a second aspect of the present invention, there is provided the optical lens unit as described in the first aspect, wherein plural plastic lenses are housed and disposed in the lens barrel; and wherein conical surfaces, which can engage with each other, are formed on superposing surfaces of the plastic lenses.

According to the optical lens unit described in the second aspect, the conical surface formed on the outer circumference of the edge portion of the plastic lens initially inserted into the lens barrel can be allowed to be in line contact with the vertical inner circumferential surface of the lens barrel for the purpose of making the lens barrel and the plastic lens concentric with each other. After the lens barrel and the plastic lens are positioned as mentioned above, the subsequent plastic lenses can be sequentially inserted into the lens barrel in such a manner that the conical surfaces formed on the superposing surfaces of the plastic lenses engage with each other. Consequently, the optical axes of all the plastic lenses housed in the lens barrel can be aligned with reference to the plastic lens that is positioned relative to the lens barrel.

According to a third aspect of the present invention, there is provided a plastic lens forming mold that forms the plastic lens described in the first aspect, the plastic lens forming mold including a fixed mold, a movable mold that can be opened and closed relative to the fixed mold, and an insert that can be removably incorporated into the fixed mold and the movable mold. The lens portion and the conical surface are formed by the insert.

According to the plastic lens forming mold described in the third aspect, the lens portion and the conical surface of the plastic lens are integrally formed by the insert. Therefore, no displacement occurs between the lens portion and the conical surface due to the clearance between the insert and the movable mold and fixed mold. It means that high dimensional accuracy can always be maintained for the lens portion and the conical surface. Consequently, the optical axis of the lens barrel can be accurately aligned with the optical axis of the plastic lens.

According to a fourth aspect of the present invention, there is provided a method of manufacturing a plastic lens, the method including the step of injection-molding the plastic lens by filling resin into a cavity surrounded by the fixed mold, the movable mold, and the insert with the plastic lens forming mold described in the third aspect.

According to the plastic lens manufacturing method described in the fourth aspect, a plastic lens can be volume-manufactured at low cost while maintaining high dimensional accuracy of the lens portion and the conical surface at all times. This makes it possible to reduce the cost of plastic lens manufacture.

When the lens portion and conical surface of a plastic lens is formed with an insert for a forming mold, the present invention makes it possible to maintain high dimensional accuracy of the lens portion and conical surface at all times. Further, when the conical surface of the plastic lens is allowed to mate with the conical receiving surface of the lens barrel for the purpose of incorporating the plastic lens into the lens barrel, accurate positioning can be achieved to ensure that the lens barrel is concentric with the plastic lens.

Furthermore, in a state where a plastic lens initially inserted into the lens barrel is positioned by allowing its conical surface to mate with the conical receiving surface of the lens barrel, subsequent plastic lenses can be sequentially inserted into the lens barrel with reference to the initially inserted plastic lens. The optical axes of all the plastic lenses housed in the lens barrel can then be aligned by allowing the conical surfaces formed on the superposing surfaces of the plastic lenses to engage with each other.

### BRIEF DESCRIPTION OF THE DRAWINGS

An embodiment of the present invention will be described in detail based on the following figures, wherein:

FIG. 1 is a cross-sectional view of an optical lens according to an embodiment of the present invention;

FIG. 2 is a schematic cross-sectional view of a plastic lens forming mold according to the embodiment;

FIG. 3 is a cross-sectional view of a conventional optical lens;

FIG. 4 is a cross-sectional view illustrating an improved version of a conventional positioning structure for a lens barrel and a plastic lens; and

FIG. 5 is a schematic cross-sectional view of a conventional plastic lens forming mold.

### DETAILED DESCRIPTION OF THE PREFERRED EMBODIMENTS

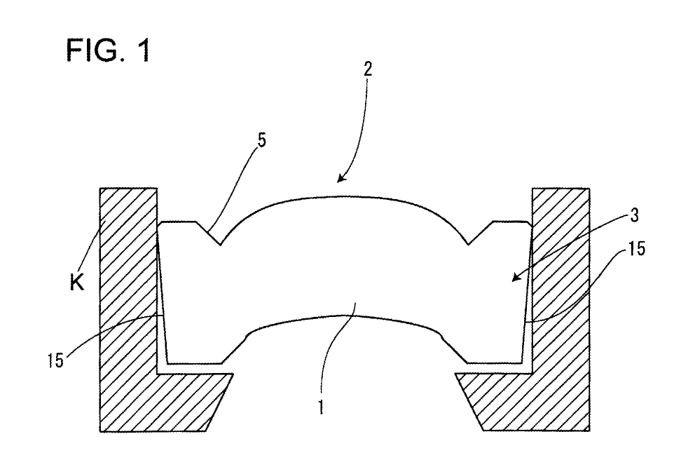

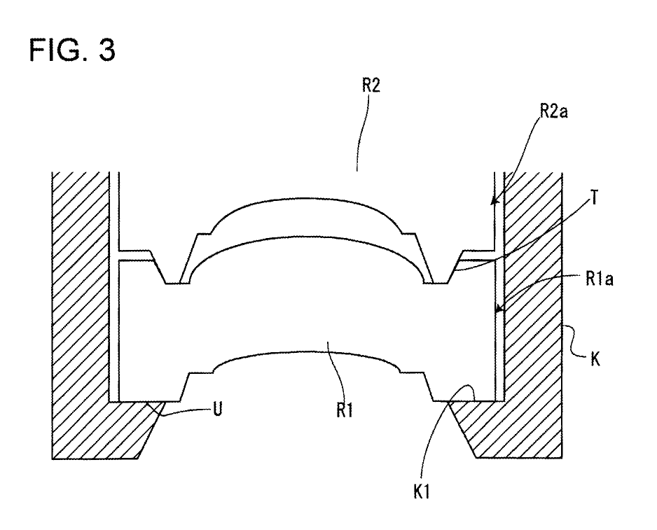

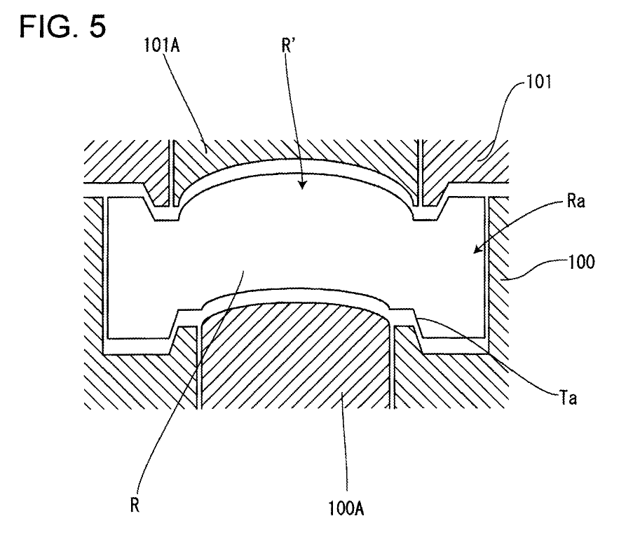

FIG. 1 is a cross-sectional view of an optical lens according to an embodiment of the present invention. Elements of the embodiment that are the same as the counterparts of conventional examples shown in FIGS. 3 and 5 will not be described. However, only the elements different from those of the conventional examples will now be described with reference numerals assigned to them.

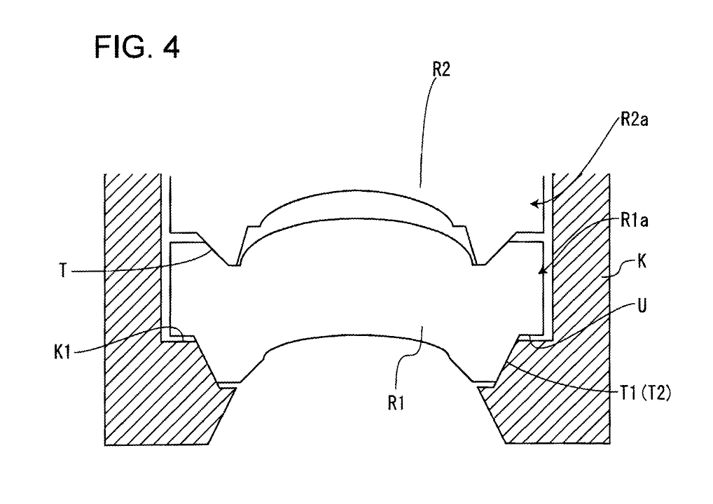

Referring to FIG. 1, the reference numeral 1 denotes a plastic lens. The plastic lens 1 includes a lens portion 2 and an edge portion 3 that is circumferentially extended from the periphery of the lens portion 2. Tapered conical surfaces 15, 5 are respectively formed on the outer circumference and upper surface of the edge portion 3. The conical surface 15 formed on the outer circumference of the edge portion 3 is tapered and inclined in a direction approaching an optical axis S as viewed from the upper surface side to the lower surface side. Further, a vertical inner circumferential surface is formed on the lens barrel K, which houses the plastic lens 1. Therefore, when the plastic lens 1 is inserted into the lens barrel K, the top edge of the conical surface 15 formed on the outer circumference of the edge portion 3 of the plastic lens 1 is brought into line contact with the vertical inner circumferential surface of the lens barrel K to center the plastic lens 1 with respect to the lens barrel K. As is the case with the improved example shown in FIG. 4, when plural plastic lens 1, plastic lens 2 . . . are to be incorporated into the lens barrel K, the conical surface 5 formed on the upper surface of the plastic lens 1 is allowed to mate with a conical surface T of a second plastic lens R2. Consequently, the optical axis of the lens barrel can be accurately aligned with the optical axes of the lenses R1, R2, . . . .

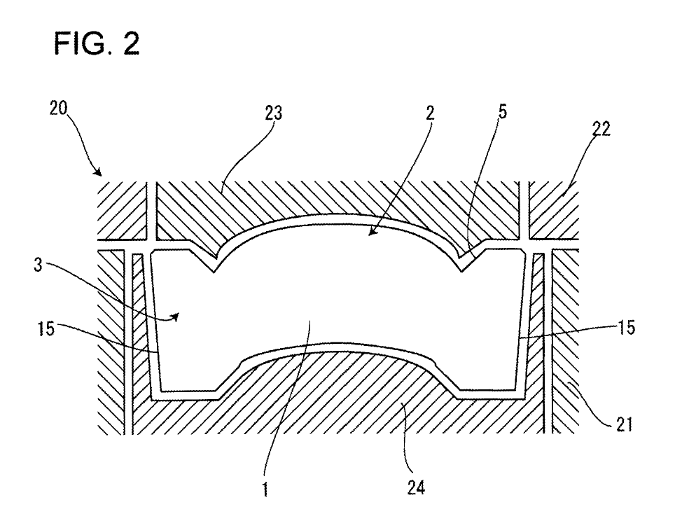

Referring to FIG. 2, the forming mold 20 for the plastic lens 1 includes a fixed mold 21, a movable mold 22, and upper and lower inserts 23, 24, which are incorporated into the fixed mold 21 and movable mold 22. The fixed mold 21 and movable mold 22 move up or down in the direction of the optical axis of the plastic lens 1 to open or close for mold clamping purposes. Molten resin is filled into a cavity surrounded by the fixed mold 21, the movable mold 22, and the inserts 23, 24 incorporated into the molds 21, 22 to injection-mold the plastic lens 1. The upper lens surface of lens portion 2 and conical surface 5 of the plastic lens 1 are integrally formed by the insert 23, and the lower lens surface of lens portion 2 and conical surface 15 of the plastic lens 1 are integrally formed by the insert 24.

In other words, the forming mold 20 for the plastic lens 1 according the present embodiment of the present invention is such that the upper lens surface of lens portion 2, which determine the optical performance of the plastic lens 1, and the conical surface 5 of the plastic lens 1 are integrally formed by the insert 23 incorporated into the movable mold 22, and the lower lens surface of lens portion 2 and the conical surface 15 of the plastic lens 1 are integrally formed by the insert 24 incorporated into the fixed mold 21. In the previously described conventional examples, it is anticipated that the lens portion 2 and the conical surfaces 15, 5 become displaced in the radial direction to cause a forming error due to clearance formed between the fixed mold 21, movable mold 22, and respective inserts 23, 24, as shown in FIG. 5. On the other hand, according to the forming mold structure of the present invention, the lens surface on the movable mold side and conical surface 5, and the lens surface on the fixed mold side and conical surface 15, are integrally formed, respectively. This makes it possible to enhance the positional accuracy of the conical surfaces 15, 5 and lens portion 2. Further, the inserts 23, 24 are removably incorporated into the fixed mold 21 and movable mold 22. Therefore, the inserts 23, 24 can be easily reshaped after forming if, for instance, the shrinkage ratio of the lens portion 2 formed by the inserts 23, 24 does not agree with a design value. Consequently, it is easy to correct the surface shape of the formed lens portion 2 toward a design value and correct the diameter of a tapered surface.

When, in the present embodiment, which is configured as described above, the lens portion 2 and the conical surfaces 15, 5 contiguous to the lens portion 2 are formed with the inserts 23, 24, the lens portion 2 can be made accurately concentric with the conical surfaces 15, 5. When, in a situation where adequate forming accuracy of the conical surfaces 15, 5, is maintained, the conical surface 15 formed on the outer circumference of the plastic lens 1 is allowed to be in line contact with the vertical inner circumferential surface of the lens barrel K for the purpose of incorporating the plastic lens 1 into the lens barrel K, accurate positioning can be achieved to make the plastic lens 1 concentric with the lens barrel K. Further, when plural plastic lenses 1, . . . are to be incorporated into the lens barrel K by sequentially allowing the conical surface 4 of subsequent plastic lenses to mate with the conical surface 5 of the plastic lens 1 with reference to the plastic lens 1 positioned relative to the lens barrel K, a unit can be formed with the optical axes of the lenses aligned and housed in the lens barrel K.

Moreover, the inserts 23, 24, which form the lens portion 2 and conical surfaces 15, 5 of the plastic lens 1, are removably incorporated into the fixed mold 21 and movable mold 22. Therefore, when, for instance, the aspheric surface shape of the inserts 23, 24 is to be changed, the surface shape of the lens portion 2 can be easily corrected toward a design value.

Furthermore, in the present embodiment, the lens barrel K can easily be formed because the shape of the lens barrel K is simplified by forming the inner circumferential surface vertically.

Although the present invention has been described in conjunction with preferred embodiments, the present invention is not limited to such the preferred embodiments. Persons of skill in the art will appreciate that variations may be made without departure from the scope and spirit of the present invention. For example, the shape of each lens may be changed. The shape of the conical surfaces for aligning the optical axes of individual lenses may be changed. The number of lenses to be incorporated into the lens barrel may be one. The number of lenses to be incorporated into the lens barrel may be determined as appropriate in accordance with a device into which the optical lens unit is to be incorporated. Further, the structure of the forming mold for forming an optical lens is not limited to the one described in connection with the first embodiment, but may be changed as appropriate.

What is claimed is:

1. An optical lens unit comprising:
a cylindrical lens barrel that has an opening at both ends; and
a plastic lens that is housed and disposed in the lens barrel;
wherein the plastic lens includes an edge portion, which is positioned on an outer circumference, and a lens portion;
wherein a tapered conical surface is formed on the outer circumference of the edge portion; and
wherein the inner circumferential surface of the lens barrel is a vertical surface that is in line contact with the conical surface.

2. The optical lens unit according to claim 1, wherein a plurality of plastic lenses are housed and disposed in the lens barrel; and wherein conical surfaces, which can engage with each other, are formed on superposing surfaces of the plastic lenses.

3. A plastic lens forming mold that forms the plastic lens according to claim 1, the plastic lens forming mold comprising:
a fixed mold;
a movable mold that can be opened and closed relative to the fixed mold; and
an insert that can be removably incorporated into the fixed mold and the movable mold;
wherein the lens portion and the conical surface are formed by the insert.

4. A method of manufacturing a plastic lens, the method comprising:
injection-molding the plastic lens by filling resin into a cavity surrounded by the fixed mold, the movable mold, and the insert with the plastic lens forming mold according to claim 3.
